(19) United States
(12) Patent Application Publication
(10) Pub. No.: US 2007/0126238 A1
(43) Pub. Date: Jun. 7, 2007

(54) Apparatus for increasing motor vehicle fuel efficiency

(76) Inventor: Justo Augusto, Daly City, CA (US)

Correspondence Address: CYBERWARE LABORATORY, 2110 DEL MONTE AVENUE, MONTEREY, CA, 939403797, US

(21) Appl. No.: 11/296,785

(22) Filed: Dec. 7, 2005

(51) Int. Cl. F01D 15/10; F02B 73/00; H02K 7/18

(52) U.S. Cl. 290/52; 60/716

(57) ABSTRACT

In one embodiment of the present invention, an apparatus for increasing motor vehicle fuel efficiency is provided that includes means for converting air flow into energy that supplements the power needs of the vehicle's power plant, thereby reducing the power plant's fuel consumption and housing means for containing the energy conversion means. In an embodiment, the means for converting air flow into energy is a multiplicity of roof mounted turbine fans.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to automobiles. More particularly, the invention relates to a device that is attached to the roof a vehicle to help increase the miles per gallon on a conventional vehicle with its own power plant, be it an engine powered by fossil fuel, hybrid, fuel cell etc.

### BACKGROUND OF THE INVENTION

Improved gas mileage for motor vehicles is a universal goal. By increasing the miles per gallon achieved by a vehicle, the driver can save money and reduce the amount of harmful pollution released into the atmosphere.

The automobile industry has resorted to many different means to increase the fuel efficiency of automobiles, such as the Hybrid vehicle, which is a good solution. However that technology is limited to specially manufactured vehicles and is not readily retrofitted to non-hybrid vehicles.

In view of the foregoing, there is a need for a device that can increase the gas mileage of a conventional vehicle.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows the side view of the housing of an exemplary mileage increasing device mounted to the roof of a vehicle, in accordance with an embodiment of the present invention;

FIG. 2 shows the front view of an exemplary mileage increasing device mounted to the roof of a vehicle, in accordance with an embodiment of the present invention;

FIG. 3 illustrates an exemplary fan and blade unit, in accordance with an embodiment of the present invention;

FIG. 4 illustrates an exemplary fan and blade unit including generator, in accordance with an embodiment of the present invention; and

FIG. 5 show the inside view of an exemplary mileage increasing device mounted to the roof of a vehicle, in accordance with an embodiment of the present invention.

Unless otherwise indicated illustrations in the figures are not necessarily drawn to scale:

### SUMMARY OF THE INVENTION

To achieve the forgoing and other objects and in accordance with the purpose of the invention, a variety of means are described for improving the fuel efficiency of motor vehicles.

In one embodiment of the present invention, an apparatus for increasing motor vehicle fuel efficiency is provided that includes means for converting air flow into energy that supplements the power needs of the vehicle's power plant, thereby reducing the power plant's fuel consumption; and housing means for containing the energy conversion means. In an embodiment, the means for converting air flow into energy is a multiplicity of roof mounted turbine fans.

Some alternate embodiment of the present invention further include at least one motorized gate disposed at the front and/or rear of the housing means; and a sensor that indicates when the vehicle is at highway speed; and gate engagement means for opening the at least one gate when the sensor indicates the vehicle is at highway speed.

Another embodiment of the present invention further includes at least one motorized gate disposed at the front and/or rear of the housing means; and a sensor that indicates the presence of water or rain outwardly near to the housing; and gate disengagement means for closing the at least one gate when the sensor indicates the presence of water or rain.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description'set forth herein.

Embodiments of the invention are discussed below with reference to the Figures. However, those skilled in the art will readily appreciate that the detailed description given herein with respect to these figures is for explanatory purposes as the invention extends beyond these limited embodiments.

One aspect of the present invention is to provide a device that can be attached to the roof of a conventional vehicle, which improves the gas mileage by using the generated wind force created by the moving vehicle to supplement the engine power.

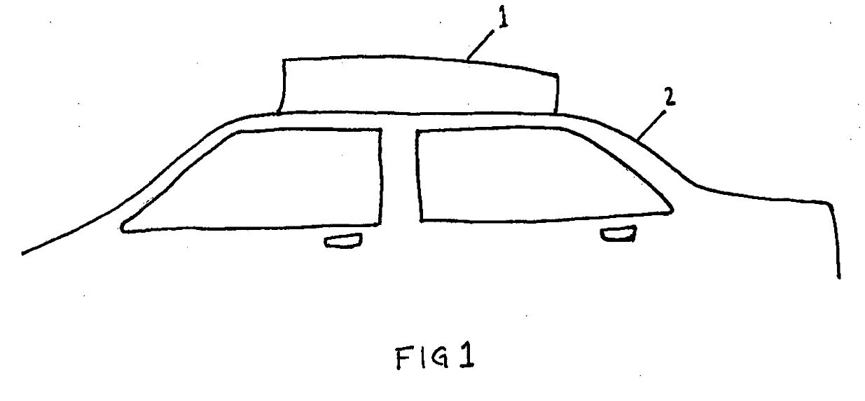

FIG. 1 shows the side view of the housing of an exemplary mileage increasing device mounted to the roof of a vehicle, in accordance with an embodiment of the present invention. In the present embodiment, a housing 1 is mounted to the roof of a conventional vehicle 2. Housing 1 contains the inner workings of the mileage increasing device. In the present embodiment, housing 1 would be aerodynamic to help reduce the resistance or drag when vehicle 2 is in motion. Vehicle 2 may be any type of vehicle with its own power plant such as, but not limited to a fossil fuel powered vehicle, a hybrid vehicle, or a vehicle powered by fuel cells.

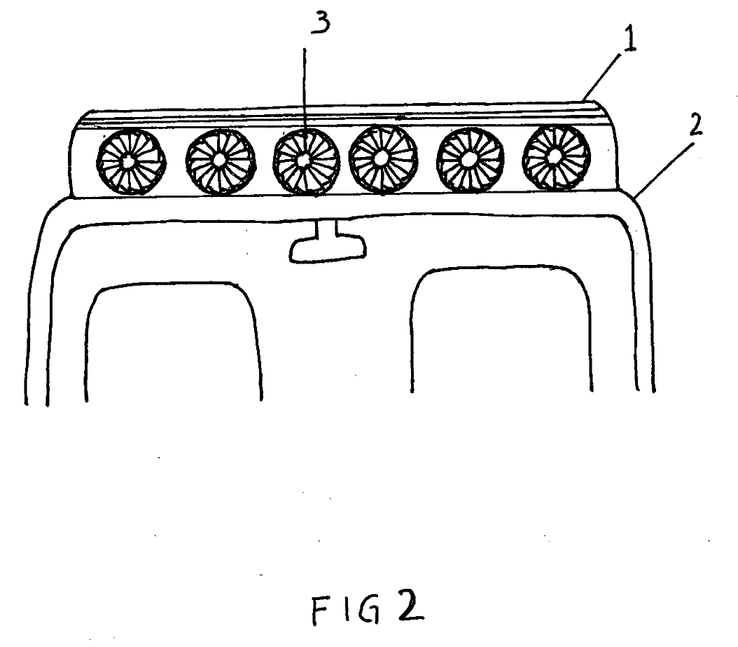

FIG. 2 shows the front view of an exemplary mileage increasing device mounted to the roof of a vehicle, in accordance with an embodiment of the present invention. In the present embodiment, housing 1 is securely mounted to the roof of vehicle 2. Housing 1 has an open front end and open back end and multiple turbine like channels 3. Each channel 3 is comprised of a fan, sets of rotatable blades, and a movable shaft connected to a power generator. In the preferred embodiment, housing 1 is comprised of six channels 3, but the number of channels can be modified depending on the size of the vehicle.

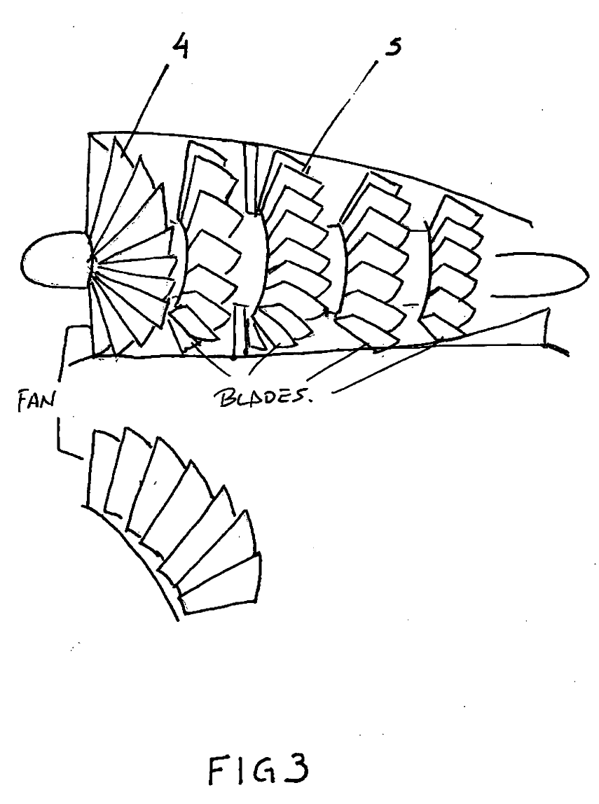

FIG. 3 illustrates an exemplary fan and blade unit, in accordance with an embodiment of the present invention. In the present embodiment, each channel, shown in FIG. 2, is comprised of multiple sets of rotatable blades 5 that are designed from greater to smaller, so it is turbine like, and a fan 4 with a diameter larger than the diameter of rotatable blades 5. Fan 4 will rotate by the wind as the vehicle is in motion; the greater the motion the faster fan 4 will rotate creating a high speed inflow of air where it is meet by the first set of rotatable blades 5 then moved to the second set of rotatable blades 5, etc. During this motion, the air will be compressed and moved at a greater speed at each consecutive smaller set of rotatable blades 5 due to the venturi type design creating force or thrust as the air exist the open end of each of the channels. It is contemplated that in some applications to create the optimal airflow speed the front opening will be wider and progressively be reduced until the optimal diameter reached in the section of the rotatable blades to thereby create pressure waves that helps maintain air density constant and thus increase airflow speed. In the preferred embodiment, this is modified only by the rotatable blades as the airflow passes through the rotatable blade section thereby increasing airflow speed.

Depending on the size of the device for a particular type of vehicle the rotatable blade section can be made uniform in diameter, thus wider in the opening and decreased to a certain diameter through the length of the rotatable blades section. For longer vehicles, the rotatable section would be longer to provide more thrust to compensate for the size and weight of the vehicle.

As the car moves at highway speeds fan 4 and rotatable blades 5 will generate enough force to assist the vehicle to keep moving forward while at the same time the operator of the vehicle will not require to use the accelerator pedal on a constant basis, thus using less engine power and increasing the number of miles traveled per gallon of gasoline. In the present embodiment, the mileage increasing device is not meant to substitute the power plant of the vehicle, just to assist the engine when it is in motion. The fans deliver energy to reduce the power plant's fuel consumption by using the incoming air flow and increasing it's velocity by way of the fans and rotatable blades, thus creating thrust to help sustain the momentum of the vehicle.

The present embodiment uses a venturi type channel, where the back opening is smaller than the front opening, because in many applications, it produces more power than a channel of uniform diameter.

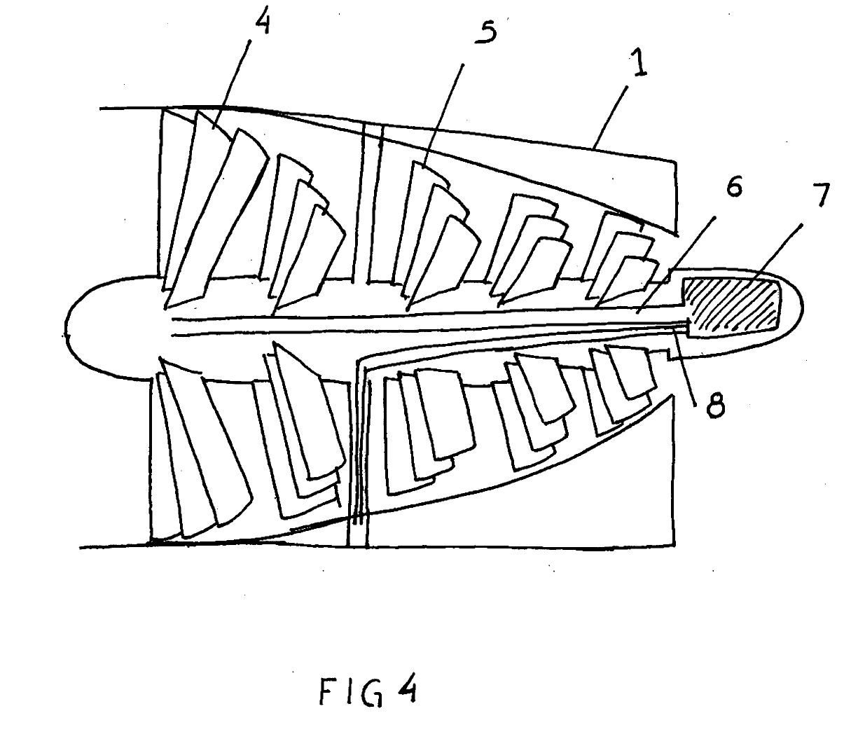

FIG. 4 illustrates an exemplary fan and blade unit including generator, in accordance with an embodiment of the present invention. In the present embodiment, fan 4 is rotated by the wind created by the movement of the vehicle, causing an intake of air to reach the sets of rotatable blades 5. As fan 4 and rotatable blades 5 rotate, they turn a movable shaft 6. Movable shaft 6 is connected to a generator 7, and when movable shaft 6 rotates, generator 7 imparts electricity to batteries inside the housing of the device via wires 8. In the present embodiment, this electricity is used to power the mileage increasing device's internal systems. Generator 7 would be able to recharge the batteries when the vehicle is in motion.

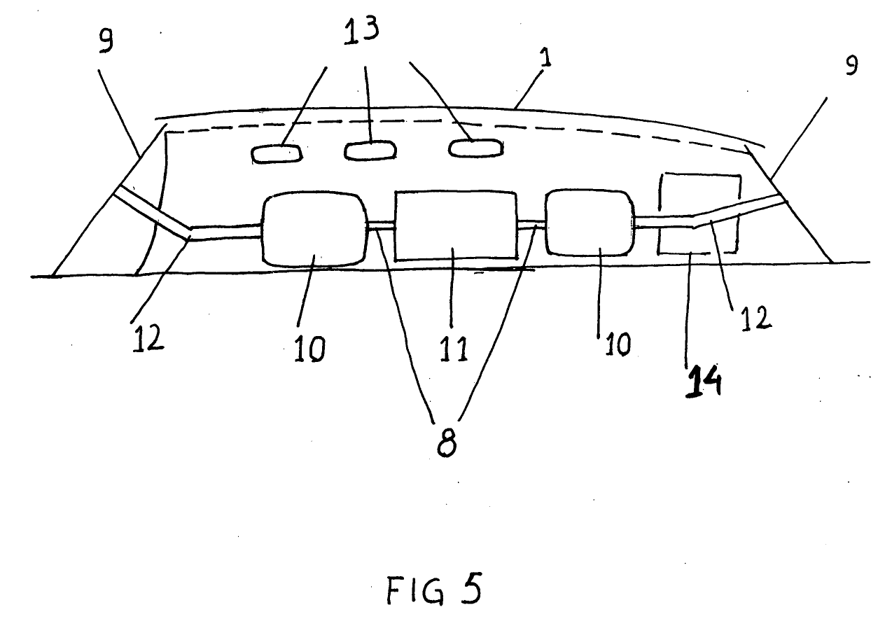

FIG. 5 show the inside view of an exemplary mileage increasing device mounted to the roof of a vehicle, in accordance with an embodiment of the present invention. In the present embodiment, motors 10 are connected to a battery 11 through wires 8. Electricity stored in battery 11 is used to power the internal systems in the mileage increasing device. These systems include, but are not limited to, motorized gates 9 on the front and real of housing 1 and sensors 13. In the present embodiment, motors 10 open and close optional gates 9 by transferring motion down shafts 12. Sensors 13 are located on the outside of housing 1. Sensors 13 determine when the vehicle is LIP to highway speed and tell motors 10 to open gates 9. Sensors 13 also detect water or rain, which would prompt motors 10 to close gates 9. In the present embodiment, in case of mechanical failure or drawn out batteries, for example, when the vehicle has been sitting for long periods of time, gates 9 can be manually opened or closed through a secured opening 14 on the side of the shell.

In alternate embodiments of the present invention, the mileage increasing device can be modified by making the shafts longer and adding more blades so it will fit on larger vehicles such as, but not limited to, vans, and buses.

In an alternate embodiment, the mileage increasing device could be simplified by having only a fan, rotating blades and a shaft. The housing in this embodiment would not have the front and rear gates, but it would have a mesh covering over the front opening to protect the fan from hard objects that might damage it.

Due to the characteristics of the preferred embodiment, for maximum performance it is preferred if the present assembly is mounted on the roof of the vehicle as shown in the Figures, however for certain types of cars or vehicles depending on the shape it can be attached to the trunk, however, this might limit the size of the present device and thus its performance.

In many applications, the design outer shell is preferably as thin and curved on the angles as possible. Typically, the fan blades would present the greatest drag in the present embodiment, thus they need to be made into a shape and angle that present minimal drag. Those skilled in the art will readily recognize how to optimally design the fan blades based on the needs of the particular application.

Having fully described at least one embodiment of the present invention, other equivalent or alternative methods of implementing a roof mounted, gas mileage increasing device for a conventional vehicle according to the present invention will be apparent to those skilled in the art. The invention has been described above by way of example, and the specific embodiments disclosed are not intended to limit the invention to the particular forms disclosed. This invention is thus to cover all modifications, equivalents, and alternatives falling within the spirit and scope of the following claims.

What is claimed is:

1. An apparatus for increasing motor vehicle fuel efficiency, the apparatus comprising:
means for converting air flow into energy that supplements the power needs of the vehicle's power plant, thereby reducing the power plant's fuel consumption; and
housing means for containing said energy conversion means.

2. The fuel efficiency improvement apparatus of claim 1, further comprising:
at least one motorized gate disposed at the front and/or rear of the housing means;
a sensor that indicates when the vehicle is at highway speed; and
gate engagement means for opening said at least one gate when the sensor indicates the vehicle is at highway speed.

3. The fuel efficiency improvement apparatus of claim 1, further comprising:
at least one motorized gate disposed at the front and/or rear of the housing means;
a sensor that indicates the presence of water or rain outwardly near to the housing;
gate disengagement means for closing said at least one gate when the sensor indicates the presence of water or rain.

4. The fuel efficiency improvement apparatus of claim 1, wherein the housing means is aerodynamically designed reduce air drag when the vehicle is in motion.

5. The fuel efficiency improvement apparatus of claim 1, wherein the housing means is fixedly mounted to the roof of the vehicle.

6. The fuel efficiency improvement apparatus of claim 1, wherein the housing means is fixedly mounted to the trunk of the vehicle.

7. The fuel efficiency improvement apparatus of claim 1, further comprising means for manually opening and/or closing said gates.
